(19) United States
(12) Patent Application Publication
(10) Pub. No.: US 2009/0184096 A1
(43) Pub. Date: Jul. 23, 2009

(54) Laser machining apparatus and method of adjusting the same

(76) Inventors: Hidehiko Karasaki, Hyogo (JP); Tsutomu Sugiyama, Osaka (JP); Hitoshi Hongu, Hyogo (JP)

Correspondence Address: WENDEROTH, LIND & PONACK L.L.P., 1030 15th Street, N.W., Suite 400 East, Washington, DC, 20005-1503, US

(21) Appl. No.: 11/597,062

(22) PCT Filed: Jul. 13, 2006
(86) PCT No.: PCT/JP2006/313939

§ 371 Date: Nov. 20, 2006

(30) Foreign Application Priority Data
Jul. 15, 2005 (JP) 2005-206440

(51) Int. Cl. B23K 26/38

(52) U.S. Cl. 219/121.72

(57) ABSTRACT

A laser machining apparatus includes a laser generator for generating a laser beam and a driver unit for moving the laser beam relatively with respect to a workpiece as to emit the laser beam on the workpiece. The laser beam includes plural laser pulses. The laser pulses have spots each having a longitudinal direction. The driver unit moves the laser beam in the longitudinal direction relatively with respect to the workpiece so that the spots overlap each other. This laser machining apparatus can process the workpiece at high quality and high productivity.

### FIELD OF THE INVENTION

The present invention relates to a laser machining apparatus for machining a workpiece with laser beam, and to a method of adjusting the apparatus.

### BACKGROUND OF THE INVENTION

Laser machining for machining a composite workpiece with laser beam without a stress to the workpiece has been demanded. If the composite workpiece is fragile, mechanical machining, such as dicing, may cause a tress or micro crack having a part of the composite be peeled off.

FIGS. 6A, 6B, and 7 illustrate a conventional method of machining process workpiece 206. FIGS. 6B and 6D are partially enlarged views of FIGS. 6A and 6C, respectively.

The workpiece 206 is made of a composite material including a base 203 and a fragile material 202 provided on the base 203 by laminating or vapor depositing technique. A groove 204 is formed in the workpiece 206 with a laser beam 201. A cutting wheel 205 is pressed on the material 202 of the workpiece 206 in order to form the groove 204, and may produce a crack and partially peel off from the base 203 due to micro cracks or stress. For avoiding such problem, the laser beam 201 is applied firstly to remove a portion of the material 202 along the groove 204 and to cause the base 203 to expose, as shown in FIGS. 6A and 6B. Then, the cutting wheel 205 is pressed into the base 203 to form the groove 204.

FIG. 7 is a schematic view of a conventional laser machining apparatus 5001 for forming a groove in the fragile material 202 with a laser beam 201 as shown in FIG. 6A. The laser machining apparatus 5001 includes a laser oscillator 101, a collimator unit 102, a bend mirror 103, a condenser 104, an X-Y movable table 105, and a workpiece table 106 for fixing the workpiece 206. The laser beam emitted from the laser oscillator 101 is converted by the collimator unit 102 into a laser beam having a predetermined beam diameter. The laser beam is reflected by the bend mirror 103 and introduced to the condenser lens 104. The condenser lens 104 focuses the laser beam on the workpiece 206 fixed onto the workpiece table 106 as to heat and remove a portion of the material 202 of the workpiece 206. While the laser beam 201 is emitted, the X-Y movable table 105 moves the workpiece 206 for forming the groove 204 having a linear shape. Since the material 202 is fragile, the laser oscillator 101 generates a pulse laser beam as the laser beam in order to prevent a surface of the material 202 from receiving a thermal stress.

The pulse laser beam allows heat per unit area of the material 202 to be controlled precisely, accordingly minimizing the thermal stress and providing accurate machining. The laser beam 201, the pulse laser, includes laser pulses produced at a predetermined interval of time. The laser beam provides a spot having a circular shape on the workpiece 206. In order to form the continuous groove 204, a spot of a laser pulse necessarily overlaps a spot of a succeeding laser pulse.

FIGS. 8A and 8B illustrate spots 201A of the laser pulses generated in the laser machining apparatus 5001 and the temperature of the material 202 of the workpiece 206. In FIGS. 8A and 8B, the horizontal axis represents positions in the groove 204A along the direction in which the groove 204A extends while the vertical axis represents temperatures of workpiece (the material 202). In FIG. 8A, the spots 201A of the laser pulses are separated from one another by a distance D11 and overlap one another along a distance D1. In FIG. 8B, the spots 201A of the laser pulses are separated by a distance D21 shorter than the distance D11 and overlap one another along a distance D2 shorter than the distance D1. In FIG. 8A, the distance D1 is long and accordingly separates the spots 201A from each other, accordingly produces a local temperature difference Δth1. In FIG. 8B, the distance D11 between the spots 201A is shorter than the distance D1 shown in FIG. 8A, accordingly producing a local temperature difference Δth2. The temperature difference Δth1 is larger than the temperature difference Δth2, and the spots 201A shown in FIG. 8A may accordingly produce the local difference of the thermal stress on the material 202, hence causing the material 202 to be peeled off or micro to have micro cracks. If the distance between the spots 201A is short as shown in FIG. 8B, the local temperature difference Δth2 is small, accordingly causing the distribution of the temperature over the material 202 to be uniform. Accordingly, the material 202 receives the thermal stress evenly, thus being prevented from being peeled off or having micro cracks. The laser pulses emitted from the laser oscillator 101 is limited in both the energy for machining and the frequency of the pulses. This reduces the efficiency of forming of the groove 20 if the spots 201A overlap one another along a large area. Thus, the conventional laser machining method hardly provides the quality and the efficiency of the machining simultaneously.

### SUMMARY OF THE INVENTION

A laser machining apparatus includes a laser generator for generating a laser beam and a driver unit for moving the laser beam relatively with respect to a workpiece as to emit the laser beam on the workpiece. The laser beam includes plural laser pulses. The laser pulses have spots each having a longitudinal direction. The driver unit moves the laser beam in the longitudinal direction relatively with respect to the workpiece so that the spots overlap each other.

This laser machining apparatus can process the workpiece at high quality and high productivity.

### BRIEF DESCRIPTION OF THE DRAWINGS

FIG. 1 is a schematic view of a laser machining apparatus according to an exemplary embodiment of the present invention.

FIG. 2A illustrates a method of machining a workpiece with the laser machining apparatus according to the embodiment.

FIG. 2B is a partially enlarged view of FIG. 2A.

FIG. 2C illustrates the method of machining the workpiece with the laser machining apparatus according to the embodiment.

FIG. 2D is a partially enlarged view of FIG. 2C.

FIG. 3 illustrates spots of laser pulses generated by the laser machining apparatus and a temperature of the workpiece according to the embodiment.

FIG. 4 illustrates a method of adjusting the laser machining apparatus according to the embodiment.

FIG. 5A illustrates another spot of the laser pulse generated by the laser machining apparatus according to the embodiment.

FIG. 5B illustrates a further spot of the laser pulse generated by the laser machining apparatus according to the embodiment.

FIG. 6A illustrates a conventional method of machining a workpiece.

FIG. 6B is a partially enlarged view of FIG. 6A.

FIG. 6C illustrates the conventional method of machining the workpiece.

FIG. 6D is a partially enlarged view of FIG. 6C.

FIG. 7 is a schematic view of a conventional laser machining apparatus.

FIG. 8A illustrates spots of laser pulses generated by the conventional laser machining apparatus and the temperature of the workpiece.

FIG. 8B illustrates other spots of the laser pulses generated by the conventional laser machining apparatus and the temperature of the workpiece.

### REFERENCE NUMERALS

301 Laser Beam
301A Spot
301B Longitudinal Direction of Spot
301C Laser Pulse
1001 Laser Machining Apparatus
2001 Laser Generator
2002 Driver Unit

### DETAIL DESCRIPTION OF THE PREFERRED EMBODIMENT

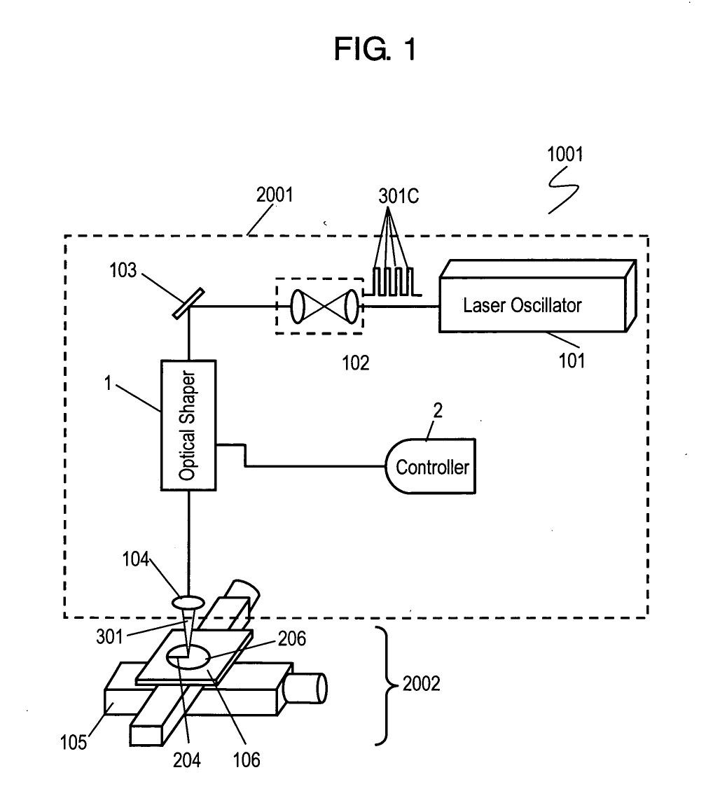

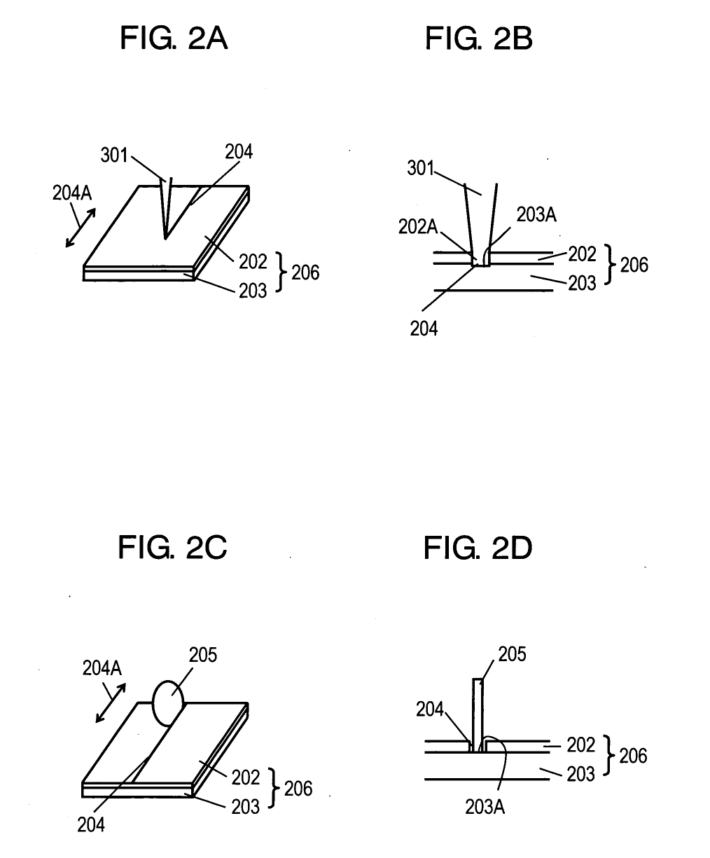

FIG. 1 is a schematic view of a laser machining apparatus 1001 according to an exemplary embodiment of the present invention. FIGS. 2A and 2C illustrate a method of machining a workpiece 206 with the laser machining apparatus 1001. FIGS. 2B and 2D are partially enlarged views of FIGS. 2A and 2C, respectively.

The workpiece 206 is made of a composite material including a base 203 and a fragile material 202 provided on the base 203 by laminating or vapor depositing technique. A laser beam 301 forms a groove 201 extending in a direction 204A in the workpiece 206. If a wheel cuter 205 is pressed onto the material 202 of the workpiece 206 in order to form the groove 204, the material 202 may be peeled off from the base 203 due to micro cracks or a stress. In order to this problem, a laser beam 201 is applied firstly to remove a portion 202A of the material 202 along the groove 204, having a portion 203A of the base 203 expose, as shown in FIGS. 2A and 2B. Then, the cutting wheel 205 is pressed into the base 203 to form the groove 204, as shown in FIGS. 2C and 2D.

The laser machining apparatus 1001 includes a laser generator 2001 and a driver unit 2002. The driver unit 2002 includes an X-Y movable table 105 and a workpiece table 106 for fixing the workpiece 206 thereto. The laser generator 2001 includes a laser oscillator 101, a collimator unit 102, a bend mirror 103, a condenser lens 104, and an optical shaper 1. A laser beam emitted from the laser oscillator 101 is converted by the collimator unit 102 into a laser beam having a predetermined beam diameter. The laser beam is reflected by the bend mirror 103 and introduced to the optical shaper 1. The laser beam emitted from the optical shaper 1 passes through the condenser lens 104. The condenser lens 104 focuses the laser beam 301 on the workpiece 206 fixed to the workpiece table 106 as to heat and remove a portion of the material 202 of the workpiece 206. While the laser beam 301 is emitted, the X-Y movable table moves the workpiece 206 in the direction 204A relatively with respect to the laser beam 301 for forming the groove 204 having a linear shape in the material 202. The material 202 is fragile, and the laser oscillator 101 generates a pulse laser as the laser beam in order to avoid a thermal stress on the workpiece 206. A controller 2 controls a rotating mechanism to control an angle of the optical shaper 1.

The pulse laser allows heat per unit area of the material 202 to be controlled precisely. Accordingly, the pulse laser minimizes the thermal stress applied to the workpiece 206, thus providing accuracy of machining. The laser beam 301 includes plural laser pulses produced at predetermined intervals of time. In order to form the continuous groove 204, a spot of a laser pulse necessarily overlaps a spot of a succeeding laser pulse.

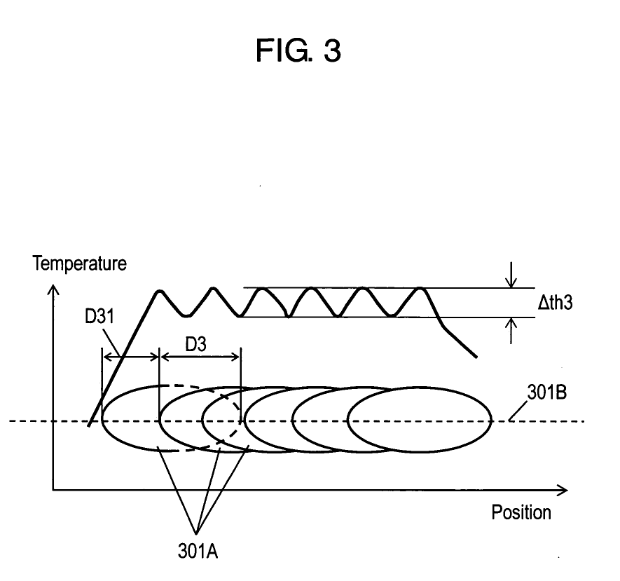

FIG. 3 illustrates the spot of the laser pulse produced by the laser machining apparatus 1001 and the temperature of the workpiece 206. The laser beam 301 includes plural laser pulses 301C. Each of the laser pulse 301C has a spot 301A having an elliptical shape having a longitudinal direction 301B, and provides the spot 301A on the workpiece 206. In FIG. 3, the horizontal axis represents positions in the groove 204A along the direction 204A while the vertical axis represents temperatures of workpiece (the material 202). The longitudinal direction 301B of the spot 301A matches with the direction 204A along which the groove 204 extends.

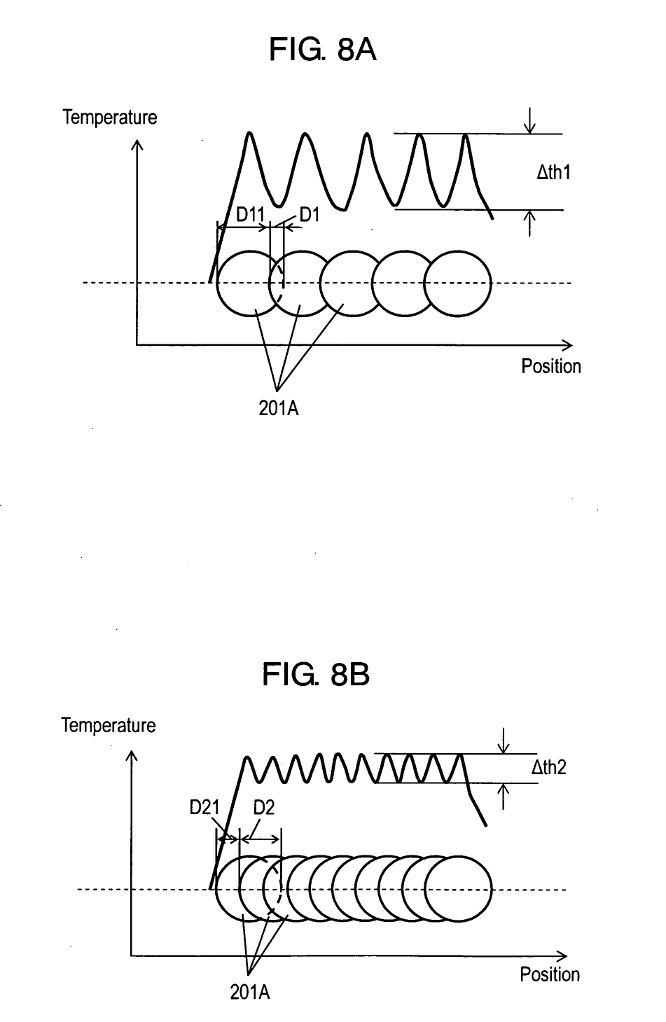

A conventional machining method using laser beam 201 having spots 201A having circular shapes shown in FIG. 8B requires a large number of spots 201A to form groove 204 having high quality. This reduces a moving speed of the workpiece 206, thus reducing productivity.

As shown in FIG. 3 illustrating the method according to the embodiment, the spot 301A has the longitudinal direction 301B matching with the direction 204A. Although the spot 301A of the laser pulse 301C and the spot 301C of the succeeding laser pulse 301C are separated from each other by a distance D31 longer than a distance D21, the spots 301A overlap each other partially along a distance D3 longer than a distance D2 along the longitudinal direction 301B. This arrangement allows a local temperature difference Δth3 to be as small as a temperature difference Δth2, and accordingly causes the distribution of heat on the material 202 of the workpiece 206 to be uniform, thus allowing the material 202 to receive a thermal stress uniformly. The material 202 is accordingly prevented from being peeled off and having micro cracks. The spot 301A of the laser pulse 301C has the elliptical shape having the longitudinal direction 301B matching with the direction 204A along which the groove 204 extends, hence allowing the distance D31 between spots 301A adjacent to each other to be long. In spite of this, the distance D3 along which the spots 301A overlap each other is long, accordingly providing a uniform energy density along the entire length of the groove 204. The spot 301A is adjusted to have energy for providing the uniform energy density along the entire length of the groove 24, thereby forming the groove 204 having high quality in the workpiece 206 at high productivity. The productivity with the spot 301A becomes higher than that with the spot 201A by the multiple of the ratio of the major axis to the minor axis of the elliptical shape of the spot 301A. Energy intensity of spot 301A may be distributed along the longitudinal direction 301B, thereby reducing a thermal stress over the workpiece 206 (material 202) due to the effect of pre-heating up and gradual cooling down.

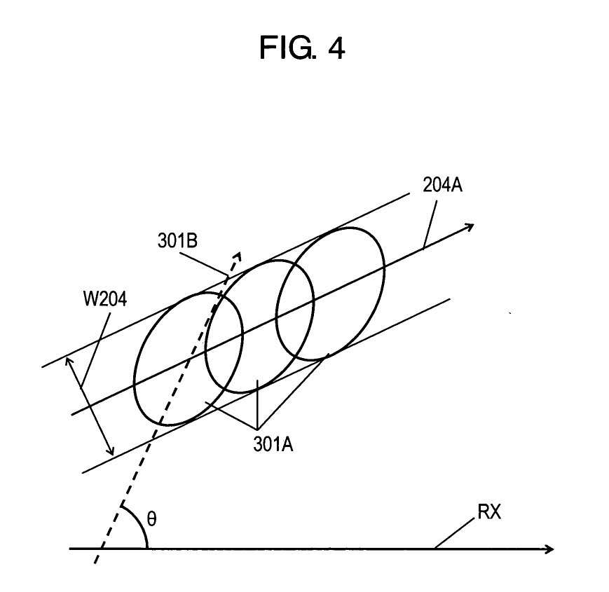

FIG. 4 illustrates a method of adjusting the laser machining apparatus 1001 including the X-Y movable table shown in FIG. 1 of the embodiment. The X-Y movable table 105 has a reference direction RX (e.g. an X-axis) for determining the X-direction and the Y-direction. During a trial process firstly executed, a width W204 of the groove 204, i.e., a processed mark, is detected. Then, the controller 2 controls the optical shaper 1 to determine an angle θ between the longitudinal direction 301B of the spot 301A and the reference direction RX so that the width W204 is minimized. Based on the width W204 of the processed mark, the controller can detects an influence of deviations of the spot 301A which are produced in directions other than a direction in which spot 301A relatively moves. If the groove 204 is along a curve line, controller 2 controls optical shaper 1 to rotate the longitudinal direction 301B of the spot 301A so that that the longitudinal direction 301B matches with the direction 204A of the groove 204 at any time. Alternatively, the X-Y movable table 105 may be replaced by an X-Y-Θ table capable of moving and rotating the workpiece 206. In this case, while the longitudinal direction 301B of the spot 301A is, the X-Y-Θ table 105 changes the longitudinal direction 301B relatively, thereby causing the longitudinal direction 301B to match with the direction 204A.

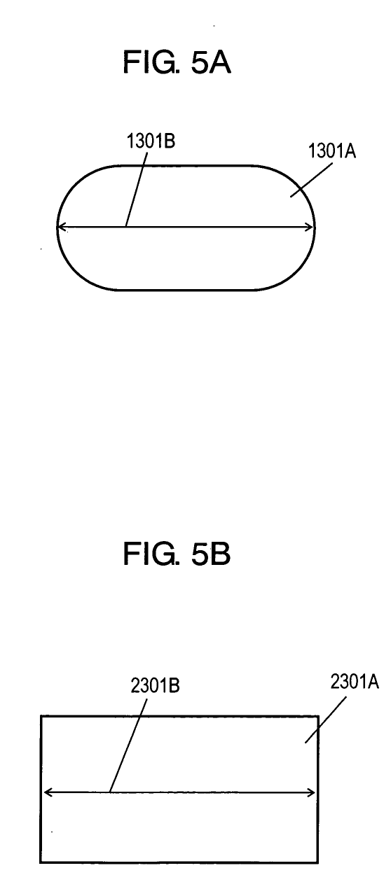

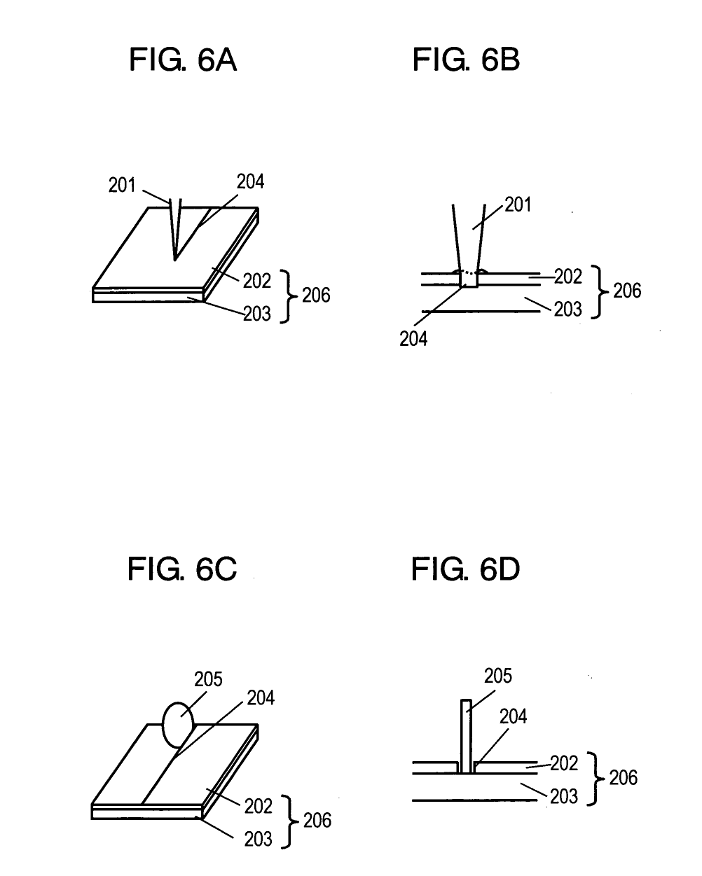

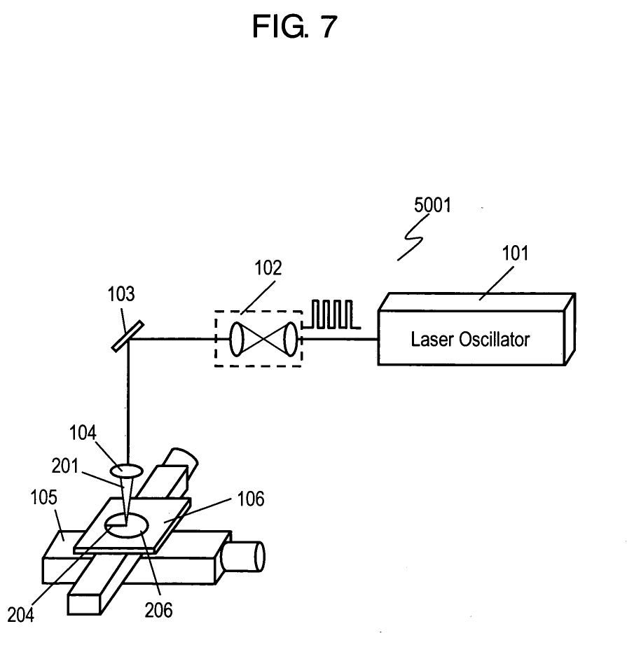

FIGS. 5A and 5B illustrate spots 1301A and 2301A of other laser pulses produced by the laser machining apparatus 1001, respectively. The laser machining apparatus 1001 of the embodiment may employ the spot 1301A having an elongated circular shape having a longitudinal direction 1301B or the spot 2301A having a rectangular shape having a longitudinal direction 2301B instead of the spot 301A having the elliptical shape of the laser pulse 301C and having the longitudinal direction 301B The longitudinal directions 1301B and 2301B match with the direction 204A of the groove 204 similarly to the longitudinal direction 301B, providing the same effects. The spot 301A may have another shape having a longitudinal direction.

### INDUSTRIAL APPLICABILITY

A laser machining apparatus according to the present invention can process a workpiece at high quality and high productivity, hence being applicable to a laser processing apparatus for forming a groove in the workpiece.

1. A laser machining apparatus comprising:
a laser generator for generating a laser beam including a plurality of laser pulses, the laser pulses having spots each having a longitudinal direction; and
a driver unit for moving the laser beam in the longitudinal direction relatively with respect to a workpiece as to emit the laser beam on the workpiece so that the spots overlap each other.

2. The laser machining apparatus according to claim 1, wherein the spot has an elliptical shape.

3. The laser machining apparatus according to claim 1, wherein the spot has an elongated circular shape.

4. The laser machining apparatus according to claim 1, wherein the spot has a rectangular shape.

5. A method of adjusting a laser machine apparatus, comprising:
providing a laser processing apparatus including a laser generator for generating a laser beam including a plurality of laser pulses, the laser pulses having spots each having a longitudinal direction;
forming a processed mark on a workpiece by emitting the laser beam onto the workpiece while moving the laser beam relatively with respect to the workpiece;
detecting a width of the processed mark; and
adjusting an angle of the longitudinal direction of the spots so that the width of the processed mark is minimized.

6. The method according to claim 5, wherein the spot has an elliptical shape.

7. The method according to claim 5, wherein the spot has an elongated circular shape.

8. The method according to claim 5, wherein the spot has a rectangular shape.
